(19) United States
(12) Patent Application Publication
(10) Pub. No.: US 2018/0253802 A1
(43) Pub. Date: Sep. 6, 2018

(54) SYSTEMS AND METHODS OF CONNECTING USERS WITH ATTENDEES AT A MEGA ATTENDANCE EVENT

(71) Applicant: SALESFORCE.COM, INC., SAN FRANCISCO, CA (US)

(72) Inventor: Ashwini Govindaraman, Hayward, CA (US)

(21) Appl. No.: 15/972,861

(22) Filed: May 7, 2018

Related U.S. Application Data
(63) Continuation of application No. 14/016,044, filed on Aug. 30, 2013.
(60) Provisional application No. 61/701,493, filed on Sep. 14, 2012.

(51) Int. Cl. G06Q 50/00; G06Q 10/10

(52) U.S. Cl. CPC G06Q 50/01; G06Q 10/10

(57) ABSTRACT

The technology disclosed relates to identifying and notifying a user of nearby attendees at a mega attendance event who are in user's social graph by comparing the user's social graph to a list of event attendees. The identified attendees can be stratified into social graph tags that annotate, categorize and prioritize other users in the user's social graph. The technology disclosed also relates to identifying and notifying the user of nearby attendees of sessions at the event who meet introduction preferences of the user by finding matches between introduction preference attributes specified by the user and attributes of the attendees provided by the list of event attendees.

### RELATED APPLICATION

The application claims the benefit of U.S. provisional Patent Application No. 61/701,493, entitled, “Recommendation Engine to Meet Relevant People in an Event Context,” filed on Sep. 14, 2012. The provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

The technology disclosed relates to identifying and notifying a user of nearby attendees at a mega attendance event who are in user's social graph by comparing the user's social graph to a list of event attendees. The identified attendees can be stratified by social graph tags that annotate, categorize and prioritize other users in the user's social graph. The technology disclosed also relates to identifying and notifying the user of nearby attendees of sessions at the event who meet introduction preferences of the user by finding matches between introduction preference attributes specified by the user and attributes of the attendees provided by the list of event attendees.

Professional events with pre-registration vary in size and regularity of attendees. Professionals attend these events to renew relationships and form new ones, in addition to learning from presentations or exhibits. Very large events include 10,000 or more attendees. It can be impractical to look at the attendee list, if one is provided. Some large events of 3,000 to 10,000 attendees may provide attendee rosters, but it is time consuming and cumbersome to go through these lists and make sense of potential connections. Medium sized events of 100 to 3,000 people may provide lists of attendees, but they provide little more than names and affiliations. Lists of this size may be practical to scan, but difficult to annotate or manage. Small events are easier to navigate, but it can be difficult to tell very much about the people in the room, without individually looking them up in a directory. One lecturer recently suggested that there is a million dollar opportunity in the room at every event you attend. But most professionals don't very often find that opportunity.

An opportunity arises to help event attendees connect with people of interest present at a mega attendance event by taking into account social graphs and introduction preferences of the event attendees. Improved user experience and engagement and higher user satisfaction and retention may result.

### SUMMARY

The technology disclosed relates to identifying and notifying a user of nearby attendees at a mega attendance event who are in user's social graph by comparing the user's social graph to a list of event attendees. The identified attendees can be stratified into social graph tags that annotate, categorize and prioritize other users in the user's social graph. The technology disclosed also relates to identifying and notifying the user of nearby attendees of sessions at the event who meet introduction preferences of the user by finding matches between introduction preference attributes specified by the user and attributes of the attendees provided by the list of event attendees.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows example systems and actors that interact for matching attendees at a mega attendance event.

FIG. 2 is one implementation of an example environment of matching attendees at a mega attendance event.

FIG. 3 shows one implementation of a plurality of objects that can be used for matching attendees at a mega attendance event.

FIG. 4 illustrates a user interface of matching attendees at a mega attendance event.

FIG. 5 is a flowchart of one implementation of finding social-graph linked attendees of a mega attendance event.

FIG. 6 illustrates a flowchart of one implementation of connecting with attendees of a mega attendance event.

FIG. 7 is a flowchart of one implementation of connecting with attendees of a session of a mega attendance event.

FIG. 8 is a block diagram of an example computer system for connecting with attendees at mega attendance event.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Examples of systems, apparatus, and methods according to the disclosed implementations are described in a “sales” context. The examples of sales events (attended by a sales representative) such as sales conferences and sales meetings are being provided solely to add context and aid in the understanding of the disclosed implementations. In other instances, examples of other events may include technology conferences, marketing campaigns, etc. attended by other user types. Other applications are possible, such that the following examples should not be taken as definitive or limiting either in scope, context or setting. It will thus be apparent to one skilled in the art that implementations may be practiced in or outside the “sales” context.

The technology disclosed relates to connecting users with attendees at a mega attendance event by using a computer-implemented system. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology may be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

The technology disclosed builds on an event organizer using scheduling based services to set up a mega attendance event to take place at a physical location and create a list of event attendees. Using the technology disclosed, the event attendees can receive the event information, including the location and selected parts of the attendee list, via their computing devices. The attendees can also receive various types of personal and business information associated with other attendees of the mega attendance event.

During a mega attendance event that has at least five-hundred (500) attendees, an attendee can use a computing device to identify other attendees who are in his social graph. This identification can be qualified to include only those attendees who are in close physical proximity to the attendee. For attendees who are already in the attendee's social graph, the technology disclosed can automatically compare the attendee's social graph to a list of event attendees, categorize overlaps by nature and strength of attendees' positions in the social graph and further prioritize the overlaps according to age, gender, professional circles, degrees of separation, interaction strengths, social proximities, and location proximities of other attendees to the attendee. In some implementations, an attendee of a session of the mega attendance event can be notified of other attendees of the session who are part of his social graph.

Even attendees who are remote in the attendee's social graph or are not found, the technology disclosed can automatically qualify such attendees based on user specified introduction preference attributes such as industry types, geographic territories, decision making authorities or expertise, products, and services. In some implementations, the introduction preference attributes can be assembled from external sources. The technology disclosed can also identify those attendees of the mega attendance event who have attributes matching the introduction preference attributes specified by the attendee. This identification can be filtered to include only those attendees who are in close physical proximity to the attendee. In some implementations, an attendee of a session of the mega attendance event can be notified of other attendees of the session who meet his introduction preferences.

### Systems and Actors

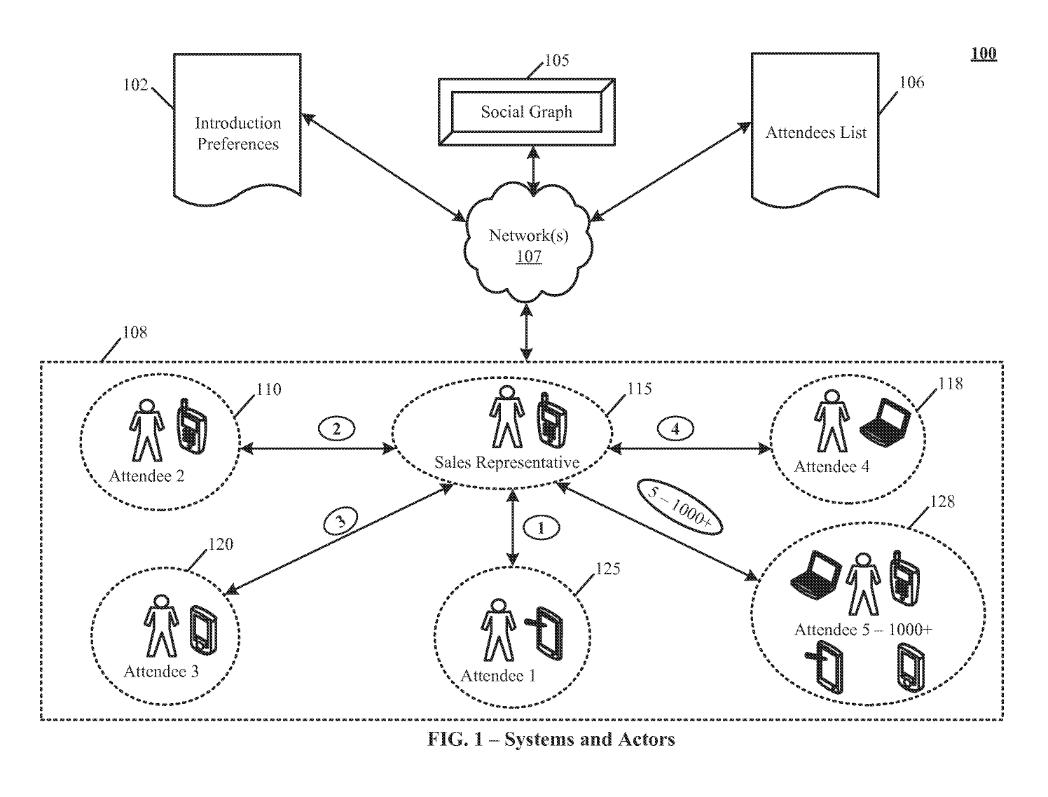

FIG. 1 shows example systems and actors 100 that interact for matching attendees at a mega attendance event 108. FIG. 1 includes introduction preferences 102, social graph 105, attendees list 106, and network(s) 107. FIG. 1 also shows a mega attendance event 108 that includes various attendees along with their devices and networks that interconnect the devices. In other implementations, systems and actors 100 may not have the same systems and/or actors as those listed above and/or may have other/different systems and actors instead of, or in addition to, those listed above. The different systems can be combined into single software modules and multiple software modules can run on the same hardware.

Introduction preferences 102 can include characteristics or attributes that a sales representative prefers in attendees of a mega attendance event 108 or may prefer to interact with at the mega attendance event 108. Such preferences can be based on sales representative's desire to identify leads or prospects at the mega attendance event 108 who are most likely to convert into accounts. Examples of such introduction preferences 102 can include, without limitations, industries in which the attendees work in, geographic territories within which the attendees are professionally active and job functions of the attendees. Notifying the sales representative of attendees who are decision makers at their organizations (based on their job functions) can save the sales representative from pitching to individuals who may not be influential in closing sales deals and can result in shortening of sales cycles for the sales representative.

Introduction preferences 102 can also specify attributes such as skills and expertise of the attendees that are of interest to the sales representative for purposes such as recruitment, identifying attendees with backgrounds similar to the sales representative, identifying experts or “gurus” in different industries, etc. For example, the sales representative can specify in the introduction preferences 102 that he seeks notification of attendees of the mega attendance event 108 who are Java developers with at least five years of experience or who are leaders in their respective industries. In some implementations, introduction preference attributes can be assembled from external sources for the attendee. Examples of external sources can include Jigsaw, Dun & Bradstreet, and the like. In some implementations, a crawler can extract introduction preference attributes by spidering person-related data sources in which the sales representative have accounts, profiles and personas.

Attendees of the mega attendance event 108, who are serviced by providers that compete with the sales representative's company to supply products and services similar to the ones sold by the sales representative, can be considered to have a profile similar to that of sales representative's target customers. Competing service providers can be listed in introduction preferences 102 to enable the system to identify attendees of the mega attendance event 108 as target customers.

Attendee list 106 can include information related to the attendees of the mega attendance event 108. In one implementation, attendee-related information can include background information of the attendees, pictures of the attendees, biographic information of the attendees such as industries in which the attendees work in, geographic territories within which the attendees are professionally active, job functions of the attendees, service providers of the attendees, contact information of the attendees, digital business cards, information on products or services offered or consumed by the attendees, advertising materials, technical specifications, written work product of the attendees, etc. This information can be written textual information, video information, digital pictures, audio information or other types of information stored in digital form. In some implementations, attendee-related information can be provided by the attendees during registration or check-in events, which can be stored in memory and aggregated to create the attendee list 106. In some implementations, a crawler can extract a list of attendees from the attendee list 106 and search those attendees on person-related data sources to spider supplemental information related to the attendees.

The attendees of the mega attendance event 108, including the sales representative, can access the attendee list 106 via communication network(s) 107. Communications network(s) 107 can be any network or combination of networks of devices that communicate with one another. For instance, network(s) 107 can be any one or any combination of Local Area Network (LAN), Wide Area Network (WAN), WiFi, telephone network, wireless network, point-to-point network, star network, token ring network, hub network, peer-to-peer connections like Bluetooth, Near Field Communication (NFC), Z-Wave, ZigBee, or other appropriate configuration including the Internet.

Social graph 105 can include online social networks of attendees on various social networking platforms like Chatter, Facebook, Twitter, LinkedIn, etc. In some implementations, social graph 105 can include records of other users in attendees' online social networks and further specify the relation and interaction types between the attendees and other users. In some implementations, social graph 105 can stratify, classify, categorize, and/or group other users in attendees' online social networks into “social graph tags” based on the preferences or interests of the attendees. The social graph tags can identify group of users in an attendee's online social network that have similar characteristics or attributes. Examples of such social graph tags or groups can include, without limitations, industry types, geographic territories, job functions, skills, expertise, products, services, age, gender, professional circles, degrees of separation, interaction strengths, social proximities, and location proximities.

Mega attendance event 108 can be any real-world event, conference and/or campaign with at least five hundred (500) attendees like Salesforce's Dreamforce event. A variety of attendees such as ‘attendee 1’, ‘attendee 2’, ‘attendee 3’, ‘attendee 4’, ‘attendees 5-1000+’, and ‘sales representative’ can use devices of different formats and physical accesses. ‘Attendee 1’ has a personal digital assistant (PDA) or tablet device linked to a wireless network 125 such as WiFi. ‘Attendee 2’ has a cell phone device configured with a telephonic network 110 such as GPRS. ‘Attendee 3’ has a smartphone device connected to a telephonic network 120 such as LTE. ‘Attendee 4’ has a laptop computer or personal computer (PC) networked to a local network 118 like WLAN. ‘Attendees 5-1000+’ represent n number of attendees at the mega attendance event 108 with various computing devices connected to different network types 128. ‘Sales representative’ has a cell phone device configured with a telephonic network 115 like CDMA. These devices and computers are coupled to network(s) 107 such that they can access the introduction preferences 102, social graph 105 and attendee list 106 and also send information to one another via the network(s) 107 if instructed to do so.

In one example, if ‘attendee 2’ and ‘attendee 1’ are in sales representative's social graph 105, then the sales representative can be automatically notified of the ‘links 2 and 1’ according one implementation described later in this application. ‘Links 2 and 1’ can be automatically stratified using the social graph tags created in social graph 105 of the sales representative. In another example, if ‘attendee 3’ and ‘attendee 4’ meet the sales representative's introduction preference attributes specified in the introduction preferences 102, then the ‘qualified matches 3 and 4’ can be reported to the sales representative according another implementation described later in this application. Similarly, ‘matches 5-1000+’ can be found among ‘attendees 5-1000+’ based on sales representative's social graph 105 and introduction preferences 102.

### Attendee Matching Environment

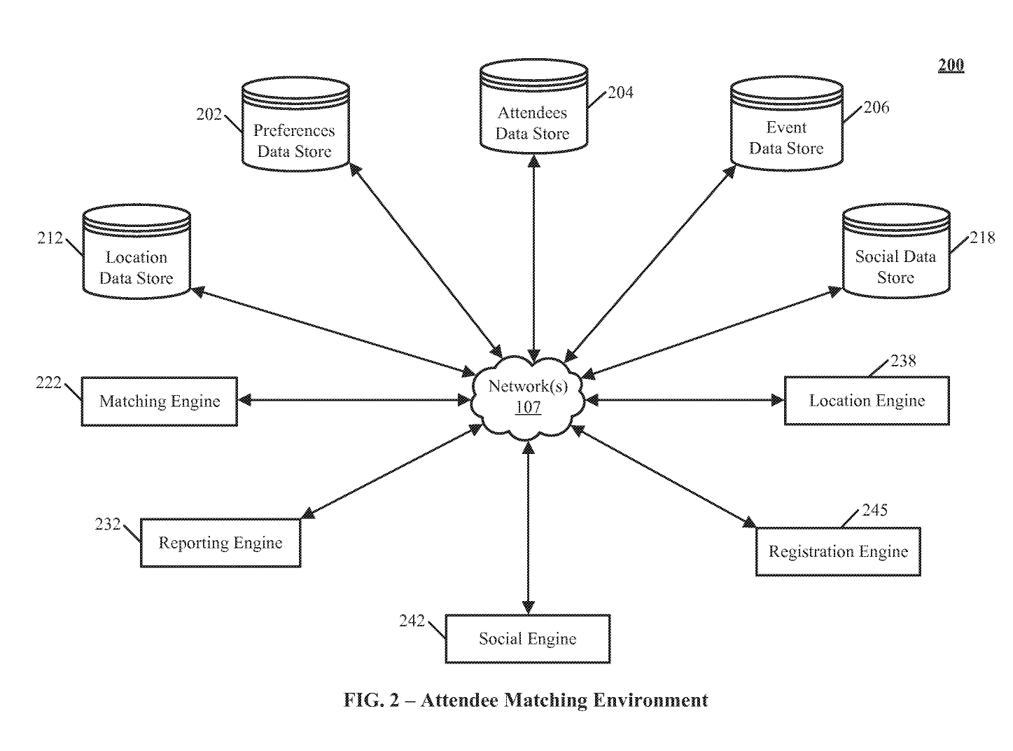

FIG. 2 is one implementation of an example environment 200 of matching attendees at a mega attendance event 108. FIG. 2 includes network(s) 107, location data store 212, preferences data store 202, attendees data store 204, event data store 206, and social data store 218. FIG. 2 also shows matching engine 222, reporting engine 232, location engine 238, social engine 242, and registration engine 245. In other implementations, environment 200 may not have the same elements as those listed above and/or may have other/different elements instead of, or in addition to, those listed above. The different elements can be combined into single software modules and multiple software modules can run on the same hardware. In other implementations, the engines can be of varying types including workstations, servers, computing clusters, blade servers, server farms, or any other data processing systems or computing devices. In yet other implementations, the data stores can be relational database management systems (RDBMSs), object oriented database management systems (OODBMSs), distributed file systems (DFS), or any other data storing systems or computing devices.

Event data store 206 can include information related to the mega attendance event 108. In some implementations, the event attendees can opt-in to the mega attendance event 108 or accept an electronic invitation for the mega attendance event 108 across a scheduling application or service running on a computing device. Based on the input provided by the event organizers and/or event attendees across the scheduling application or service, event data store 206 can specify information such as event name, start date, end date, and the location where the event may take place (e.g., city, state, country). It can also include other event-related data, including lists of attendees of the mega attendance event 108 and number of attendees at the mega attendance event 108.

The mega attendance event 108 can have multiple concurrent sessions and/or exhibits. Event data store 206 includes lists of sessions and exhibits of the mega attendance event 108 along with the number of attendees that have registered for the sessions and exhibits. Sessions are presentations to groups of event attendees, and exhibits can be company displays, such as a booth on the event floor. Event data store 206 can specify sessions and exhibits by name and location, and additionally specify sessions using a summary of the session content, a start time, and an end time. It can also include personalized schedules of individual attendees, which can list the sessions or exhibits that the attendee may have registered for.

Preferences data store 202 can include characteristics or attributes that the sales representative prefers in other attendees of the mega attendance event 108. The preference attributes can include industry types of attendees, geographic territories of attendees, job functions of attendees, products and/or services sold by the sales representative, list of service providers that are user's competitors. In some implementations, the sales representative can specify his or her preferences across a user interface of an attendee matching application running on a computing device.

Location data store 212 can hold location information related to attendees at the mega attendance event 108. In some implementations, location data store 212 can store at least calendar entries, event subscriptions, sign-ins, and check-ins or references to the same related to the mega attendance event 108. In another implementation, it can provide specific details related to the mega attendance event 108 such as longitudes and latitudes of geographic locations of the mega attendance event 108. In one implementation, it can include elevation. In one implementation, the sales representative can populate the location data store 212 by specifying location of the mega attendance event 108 on a calendar application or service running on a computing device such as a personal computer, laptop computer, tablet computer, smartphone, etc.

Location engine 238 can receive a location reference request from a computing device that includes a location data transceiver coupled to a processor. In some implementations, location engine 238 can be repeatedly invoked for different locations to obtain data from location data store 212 that holds location awareness records related to the attendees of the mega attendance event 108, which can be retrieved or constructed dynamically by requesting and combining data from registrations or check-ins.

Location engine 238 can identify an attendee's location and store it as a location record in the location data store 212. The location record can include latitude and longitude co-ordinates of attendee's real-time geographic location. In one implementation, it can include elevation. In some implementations, location engine 238 can obtain location information of the attendee when the attendee arrives at the mega attendance event 108 that is equipped with WiFi, NFC technology or quick response (QR) codes programmed to interact with wireless communication devices. In both of these examples, a smartphone can be equipped with the requisite communications and/or imaging capabilities to communicate with the on-site equipment and communicate results to a remote server such as the location engine 238.

The arrival of an attendee at the mega attendance event 108 can be automatically detected by the registration engine 245 using GPS, WiFi, NFC, or QR codes. In some implementations, registration engine 245 can perform position comparisons using GPS information to ascertain that the attendee is within ten feet of another attendee at the mega attendance event 108. Other threshold distances in a range of 5, 10, 20 or 50 feet can be used. This verification can be used to initiate a check-in process. In other implementations, WiFi fingerprints/triangulation, NFC proximity and/or QR scanning codes can be used to immediately detect the arrival of the attendee at the mega attendance event 108. Once the arrival is detected, a check-in process can be automatically initiated.

In one implementation, the mega attendance event 108 can have event registrations that include detailed attendee profile questionnaires. A check-in request can be automatically generated by the registration engine 245 when an attendee's arrival is detected at the mega attendance event 108. This can be in the form of a check-in request presented to the attendee via his or her smartphone or other mobile computing device. In one implementation, the check-in request can be fully automatic, providing only a short message via the device. In another implementation, the attendee can be presented with a prompt and a response can be requested. In yet another implementation, the check-in can proceed silently without notifying the attendee. Also, an application running on the mobile computing device can be configured to automatically connect wirelessly at check-in. A check-in request can be generated when a check-in response is received from an attendee. In one implementation, the check-in response can be initiated in response to an attendee's actions such as selecting an indicator displayed on a screen of a mobile communications device. In another implementation, the attendee can share his or her check-in information with other attendees of the mega attendance event 108. In any of the above or other implementations, the check-in request can be delayed for a period of time or an indicator can be set to show that a check-in request is pending and that a response is awaited.

Attendees data store 204 can also include records of real-world attendees, including individuals, groups, organizations, etc. present at the mega attendance event 108 or mentioned or encoded in social graph 105. In one implementation, these attendees can have accounts registered at social networking sites like Chatter, Facebook, Twitter, LinkedIn, etc. In another implementation, attendees data store 204 can hold attendee mentions along with supplemental attendee attributes such as names, addresses, job titles, usernames, contact information, employer names, etc.

Attendee mentions can be web or database profiles of the real-world attendees stored as a system of interlinked hypertext documents that can be accessed via the network(s) 107 (e.g., the Internet). Examples of attendee mentions can include social profiles, social handles, unified resource locators (URLs), business-to-business contacts, etc. In some implementations, attendees data store 204 can hold business-to-business data such as accounts, contacts and leads along with some supplemental information. In some implementations, this supplemental information can be industry types, geographic territories, job functions, products or services consumed, and other attendee-related information. In one implementation, attendee data store 204 can be a general data store from which data regarding attendees is accessed or extracted.

Social data store 218 can include social media content gathered from various person-related data sources. Such content can include social media sources, social accounts, social personas, social profiles, social handles, content shared, feed items, posts, etc. related to the attendees of the mega attendance event 108. Regarding different types of person-related data sources, access controlled application programming interfaces (APIs) like Yahoo Boss, Facebook Open Graph, Twitter Firehose can provide real-time search data aggregated from numerous social media sources such as LinkedIn, Yahoo, Facebook, and Twitter. APIs can initialize sorting, processing and normalization of person-related data. Public internet can provide person-related data from public sources such as first hand websites, blogs, web search aggregators, and social media aggregators. Social networking sites can provide person-related data from social media sources such as Twitter, Facebook, LinkedIn, and Klout. The person-related data source can be connected to network(s) 107, which is crawled by social engine 242 that searches the person-related data sources to retrieve person-related data, including social media content and web data associated with business-to-business contacts.

Matching engine 222 can identify attendees who meet the preferences specified by the sales representative in the preferences data store 202. It can also find matches between persons in the social data store 218 and attendees listed in the attendees data store 204 based on analysis of their respective attributes. In some implementations, matching engine 222 can compare alphanumeric characters in attendee mentions to supplemental information of the attendees. In one implementation, it can find common online social connections between the attendees, which can be stored in the attendees data store 204.

Reporting engine 232 can present the results generated by the matching engine 222 across a user interface of a computing device. In some implementations, it can run analytics such as annotation, clustering, classification, and prioritization over the results generated by the matching engine 222. In some implementations, reporting engine 232 can stratify the results generated by the matching engine 222 into industry types, geographic territories, job functions, skills, and expertise preferred by the sales representative, professional circles of the sales representative, degrees of separation with the sales representative, interaction strengths with the sales representative, social proximities to the sales representative, and location proximities to the sales representative.

### Attendee Matching Records

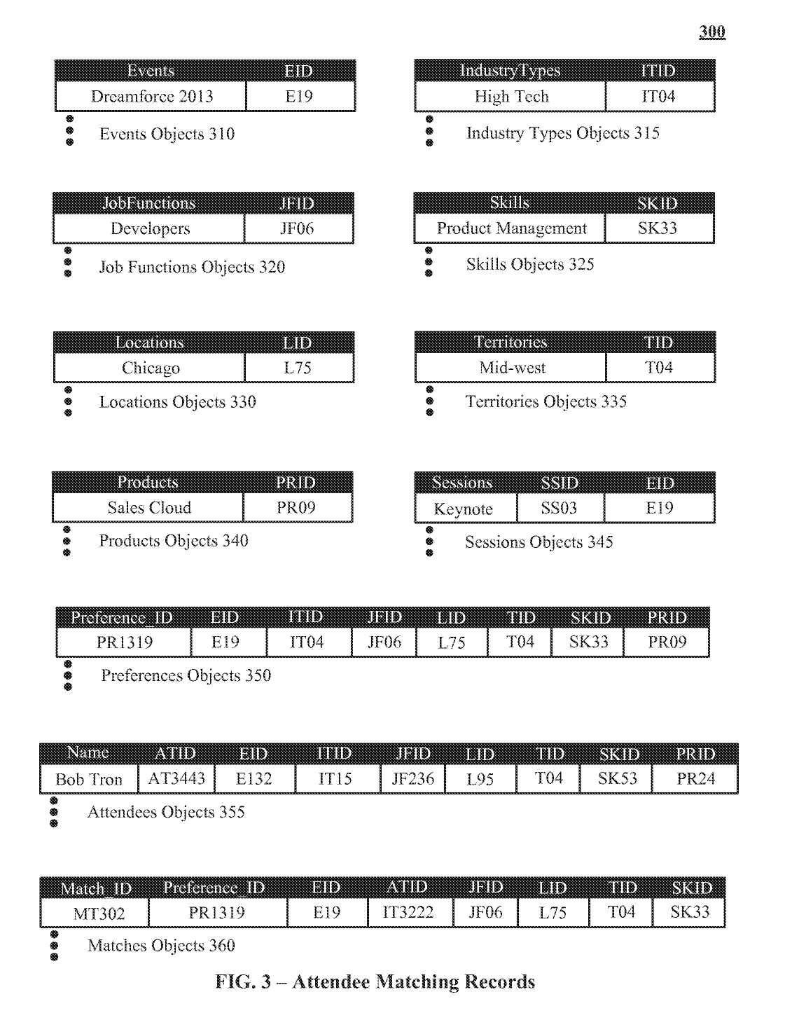

FIG. 3 shows one implementation 300 of a plurality of objects that can be used for matching attendees at a mega attendance event 108. As described above, this and other data structure descriptions that are expressed in terms of objects can also be implemented as tables that store multiple records or object types. Reference to objects is for convenience of explanation and not as a limitation on the data structure implementation. FIG. 3 shows events objects 310, industry types objects 315, job function objects 320, skills objects 325, locations objects 330, territories objects 335, products objects 340, and sessions objects 345. FIG. 3 also includes preferences objects 350, attendees objects 355 and matches objects 360. In other implementations, implementation 300 may not have the same objects, tables, entries or fields as those listed above and/or may have other/different objects, tables, entries or fields instead of, or in addition to, those listed above.

Event objects 310 specify mega attendance events, which have at least five-hundred (500) attendees. In one implementation, event objects 310 can include columns that identify names of mega attendance events along with their event IDs referred to as “EID.” As shown in FIG. 3, objects 310 can uniquely identify a mega attendance event as “Dreamforce 2013” and assign it an EID of “E19.”

In another implementation, event objects 310 can have one or more of the following variables with certain attributes: USER_ID being CHAR (15 BYTE), ORGANIZATION_ID being CHAR (15 BYTE), REGION_ID being CHAR (15 BYTE), CREATED_BY being CHAR (15 BYTE), CREATED_DATE being DATE, and DELETED being CHAR (1 BYTE). In one implementation, new entries can be added chronologically with a new record ID, which can be incremented in order. The first key prefix can provide a key that is unique to a group of records, e.g., custom records (objects). The “organization” variable can provide an ID of an organization to which the record is related. The “created by” variable can track the user who is performing the action that results in the record. The “created date” variable can specify the time stamp of record creation. The deleted variable can indicate that the record was deleted, and thus the record is not generated.

Attendees data store 204 can use industry types objects 315 to specify professional industries attendees of mega attendance event 108 that are of interest to the sales representative. Attendees data store 204 can use industry types objects 315 to store industries to which attendees of the mega attendance event 108 belong to. In one implementation, industry types objects 315 can include columns that identify industry types along with their industry type IDs referred to as “ITID.” As shown in FIG. 3, objects 315 can uniquely identify an industry type as “IT04,” which refers to “High Tech” industry.

In another implementation, industry types objects 315 can have one or more of the following variables with certain attributes: CLASSIFICATION_SYSTEM_ID being CHAR (15 BYTE), ORGANIZATION_ID being CHAR (15 BYTE), REGION_ID being CHAR (15 BYTE), CREATED_BY being CHAR (15 BYTE), CREATED_DATE being DATE, and DELETED being CHAR (1 BYTE).

Attendees data store 204 can use job functions objects 320 to specify job functions of attendees of mega attendance event 108 that the sales representative prefers to be notified of. In one implementation, job functions objects 320 can include columns that identify job functions along with their job function IDs referred to as “JFID.” As shown in FIG. 3, objects 320 can uniquely identify a job function as “Developers” and assign it a JFID of “JF06.”

In another implementation, job functions objects 320 can have one or more of the following variables with certain attributes: USER_ID being CHAR (15 BYTE), ORGANIZATION_ID being CHAR (15 BYTE), REGION_ID being CHAR (15 BYTE), CREATED_BY being CHAR (15 BYTE), CREATED_DATE being DATE, and DELETED being CHAR (1 BYTE).

Attendees data store 204 can use skills objects 325 to specify skills and expertise that the sales representative prefers in attendees of mega attendance event 108. In one implementation, skills objects 325 can include columns that identify skills along with their skill IDs referred to as “SKID.” As shown in FIG. 3, objects 325 can uniquely identify a skill as “Product Management” and assign it a SKID of “SK33.”

In another implementation, skills objects 325 can have one or more of the following variables with certain attributes: USER_ID being CHAR (15 BYTE), ORGANIZATION_ID being CHAR (15 BYTE), INDUSTRY_ID being CHAR (15 BYTE), CREATED_BY being CHAR (15 BYTE), CREATED_DATE being DATE, and DELETED being CHAR (1 BYTE).

Location data store 212 can specify geographic locations of mega attendance events and their attendees using locations objects 330. In one implementation, locations objects 330 can include columns that identify location names along with location IDs referred to as “LID.” As shown in FIG. 3, objects 330 can uniquely identify a location as “Chicago” and assign it a LID of “L75.”

In another implementation, locations objects 330 can have one or more of the following variables with certain attributes: REGION_ID being CHAR (15 BYTE), ORGANIZATION_ID being CHAR (15 BYTE), ZIPCODE_ID being CHAR (15 BYTE), CREATED_BY being CHAR (15 BYTE), CREATED_DATE being DATE, and DELETED being CHAR (1 BYTE).

Territories objects 335 can provide a list of territories that are of interest to the sales representative for identifying attendees of mega attendance event 108 that are professionally active in the listed territories. Examples of territories can include Mid-west, East coast, West coast, etc. Territories objects 335 can include columns that specify names of territories along with their territory IDs referred to as “TID.” As shown in FIG. 3, objects 335 can uniquely identify a territory as “Mid-west” and assign it a TID of “T04.”

Territories objects 335 can have one or more of the following variables with certain attributes: ZIPCODE_ID being CHAR (15 BYTE), COUNTRY_ID being CHAR (15 BYTE), STATE_ID being CHAR (15 BYTE), CREATED_BY being CHAR (15 BYTE), CREATED_DATE being DATE, and DELETED being CHAR (1 BYTE).

Products objects 340 can list products and services sold by the sales representative so as to find attendees of the mega attendance event 108 that consume similar products and services provided by competitors of sales representative's organization. Products objects 340 can include columns that specify names of products along with their product IDs referred to as “PRID.” As shown in FIG. 3, objects 340 can uniquely identify a product as “Sales Cloud” and assign it a PRID of “PR09.”

Products objects 340 can have one or more of the following variables with certain attributes: IN_HOUSE_PRODUCT_ID being CHAR (15 BYTE), IN_HOUSE_SERVICE_ID being CHAR (15 BYTE), COMPETITOR_ID being CHAR (15 BYTE), CREATED_BY being CHAR (15 BYTE), CREATED_DATE being DATE, and DELETED being CHAR (1 BYTE).

Event data store 206 can use sessions objects 345 to list sessions and exhibits of the mega attendance event 108 along with the number of attendees that have registered for the sessions and exhibits, and other information related to the sessions and exhibits. In one implementation, sessions objects 345 can include columns that identify names of sessions along with their session IDs referred to as “SSID” and the parent mega attendance event. As shown in FIG. 3, objects 345 can uniquely identify a session as “Keynote” and assign it a SSID of “SS03” and the parent mega attendance event, Dreamforce 2013 (E19).

In another implementation, sessions objects 345 can have one or more of the following variables with certain attributes: ATTENDANCE_ID being CHAR (15 BYTE), NAME_ID being CHAR (15 BYTE), LOCATION_ID being CHAR (15 BYTE), SCHEDULE_ID being CHAR (15 BYTE), SUMMARY_ID being CHAR (15 BYTE), ORGANIZATION_ID being CHAR (15 BYTE), USER_ID being CHAR (15 BYTE), CREATED_BY being CHAR (15 BYTE), CREATED_DATE being DATE, and DELETED being CHAR (1 BYTE).

Preferences data store 202 can use preferences objects 350 to hold introduction preferences of the sales representative. In one implementation, preferences objects 350 can include columns that identify preference attributes along with the preference ID referred to as “Preference_ID.” As shown in FIG. 3, objects 350 can uniquely identify an introduction preference of the sales representative and assign it a Preference_ID of “PR1319.”

In another implementation, preferences objects 350 can have one or more of the following variables with certain attributes: USER_ID being CHAR (15 BYTE), ORGANIZATION_ID being CHAR (15 BYTE), EVENT_ID being CHAR (15 BYTE), INDUSTRY_ID being CHAR (15 BYTE), ROLE_ID being CHAR (15 BYTE), LOCATION_ID being CHAR (15 BYTE), TERRITORY_ID being CHAR (15 BYTE), SKILL_ID being CHAR (15 BYTE), PRODUCT_ID being CHAR (15 BYTE), CREATED_BY being CHAR (15 BYTE), CREATED_DATE being DATE, and DELETED being CHAR (1 BYTE).

Attendees data store 204 can use attendees objects 355 to hold attributes of attendees of the mega attendance event 108. In one implementation, attendees objects 355 can include columns that identify attendee attributes along with the attendee ID referred to as “ATID.” As shown in FIG. 3, objects 355 can uniquely identify an attendee named “Bob Tron” with ATID of “AT3443.”

In another implementation, attendees objects 355 can have one or more of the following variables with certain attributes: ATTENDEE_ID being CHAR (15 BYTE), ORGANIZATION_ID being CHAR (15 BYTE), EVENT_ID being CHAR (15 BYTE), INDUSTRY_ID being CHAR (15 BYTE), ROLE_ID being CHAR (15 BYTE), LOCATION_ID being CHAR (15 BYTE), TERRITORY_ID being CHAR (15 BYTE), SKILL_ID being CHAR (15 BYTE), PRODUCT_ID being CHAR (15 BYTE), CREATED_BY being CHAR (15 BYTE), CREATED_DATE being DATE, and DELETED being CHAR (1 BYTE).

Attendees that are found to match the sales representative's introduction preferences and/or are in his social graph can be stored as matches objects 360. In one implementation, matches objects 360 can include columns that identify attendee attributes that match the introduction preference attributes along with the match ID referred to as “Match_ID.” As shown in FIG. 3, objects 360 can uniquely identify a match with Match_ID of “MT302.”

In another implementation, matches objects 360 can have one or more of the following variables with certain attributes: ATTENDEE_ID being CHAR (15 BYTE), ATTENDEE_ORGANIZATION_ID being CHAR (15 BYTE), USER_ID being CHAR (15 BYTE), USER_ORGANIZATION_ID being CHAR (15 BYTE), PREFERENCE_ID being CHAR (15 BYTE), EVENT_ID being CHAR (15 BYTE), INDUSTRY_ID being CHAR (15 BYTE), ROLE_ID being CHAR (15 BYTE), LOCATION_ID being CHAR (15 BYTE), TERRITORY_ID being CHAR (15 BYTE), SKILL_ID being CHAR (15 BYTE), PRODUCT_ID being CHAR (15 BYTE), CREATED_BY being CHAR (15 BYTE), CREATED_DATE being DATE, and DELETED being CHAR (1 BYTE).

### User Interface

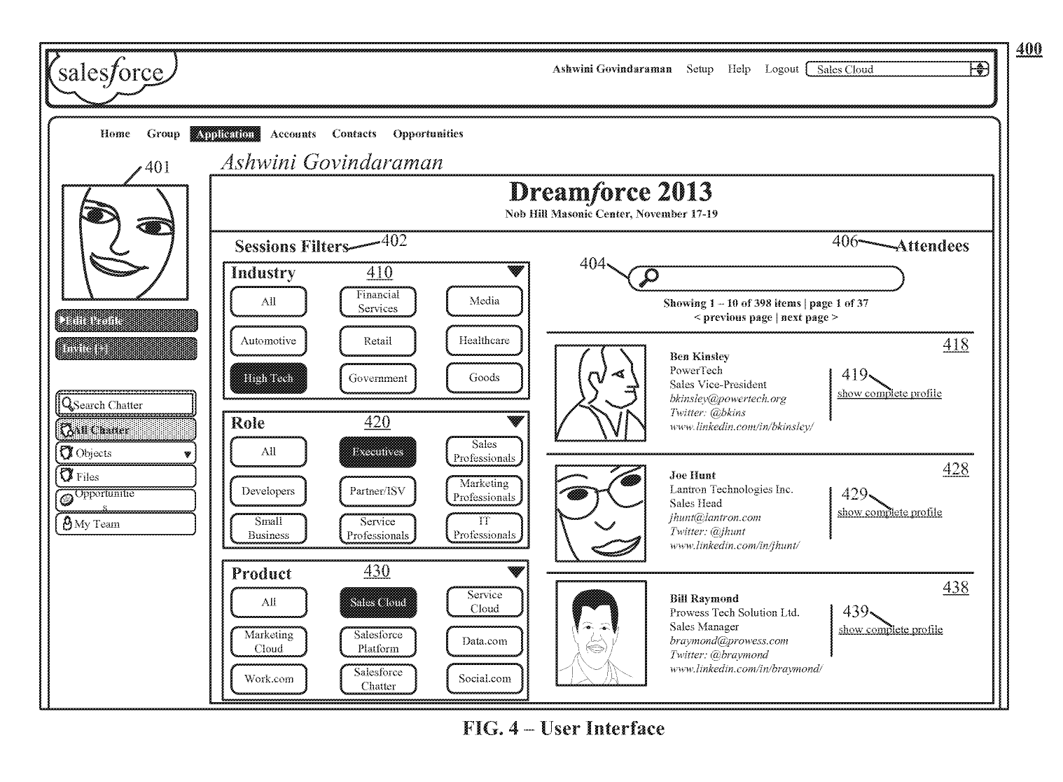

FIG. 4 illustrates a user interface 400 of matching attendees at a mega attendance event 108 such as Salesforce's “Dreamforce 2013” hosted at Nob Hill Masonic Center from November 17-19. In particular, FIG. 4 illustrates an example profile of user 401 named “Ashwini Govindaraman” on an online social network such as Salesforce's Chatter, which hosts an attendee matching application. In some implementations, user interface 400 can be presented on different online social environments such as Klout, Facebook, Twitter, LinkedIn, etc. FIG. 4 also shows a search filters tab 402, industry tab 410, role tab 420, product tab 430, search tab 404, attendees tab 406, attendee profiles tabs 418, 428 and 438, and completed profile tabs 419, 429 and 439. In other implementations, user interface 400 may not have the same widgets or screen objects as those listed above and/or may have other/different widgets or screen objects instead of, or in addition to, those listed above.

User interface 400 can provide an interface for finding attendees that match user criteria specified through industry tab 410, role tab 420 and product tab 430. In one implementation, user interface 400 can take one of a number of forms, including a dashboard interface, engagement console, and other interface, such as a mobile interface or summary interface.

User interface 400 can be hosted on a web-based or cloud-based attendee matching application running on a computing device such as a personal computer, laptop computer, mobile device, and/or any other hand-held computing device. It can also be hosted on a non-social local application running in an on-premise environment. In one implementation, user interface 400 can be accessed from a browser running on a computing device. The browser can be Chrome, Internet Explorer, Firefox, Safari, etc. In another implementation, user interface 400 can run as an engagement console on a computer desktop application primarily used for attendee matching by multiple users.

User 401 can specify her search criteria in sessions filters tab 402 to filter qualifying attendees from attendee list 105 of mega attendance event 108. In some implementations, user 401 can highlight her introduction preference attributes such as industry types, job functions and products via industry tab 410, role tab 420 and product tab 430 respectively. For instance, user 401 can set her introduction preferences to identify attendees of mega attendance event 108 who work as “executives” of “high tech” companies that sell software related to “sales cloud.” In one implementation, user 401 can directly search for an attendee of mega attendance event 108 in search tab 404.

Attendees tab 406 can display the attendees of mega attendance event 108 that meet the criteria specified by the user 401. Matched attendees (418, 428 and 438), ‘Ben Kinsley’, ‘Joe Hunt’ and ‘Bill Raymond’, can be identified through their digital business cards, images, contact information, social handles, etc. along with supplemental attendee information accessible through drill down features of complete profile tabs 419, 429 and 439. In one implementation, user interface 400 can also include other filters such as attributes of sessions and exhibits. Examples of such attributes can include, without limitations, names, locations, summary of content, speaker, etc. of the sessions and exhibits. Other filters can include attendees that are tagged in the social graph of user 401 such as industry types, geographic territories, job functions, skills, expertise, products, services, service providers, age, gender, professional circles, degrees of separation, interaction strengths, social proximities, and location proximities.

### Flowchart of Finding Social-Graph Linked Attendees at a Mega Attendance Event

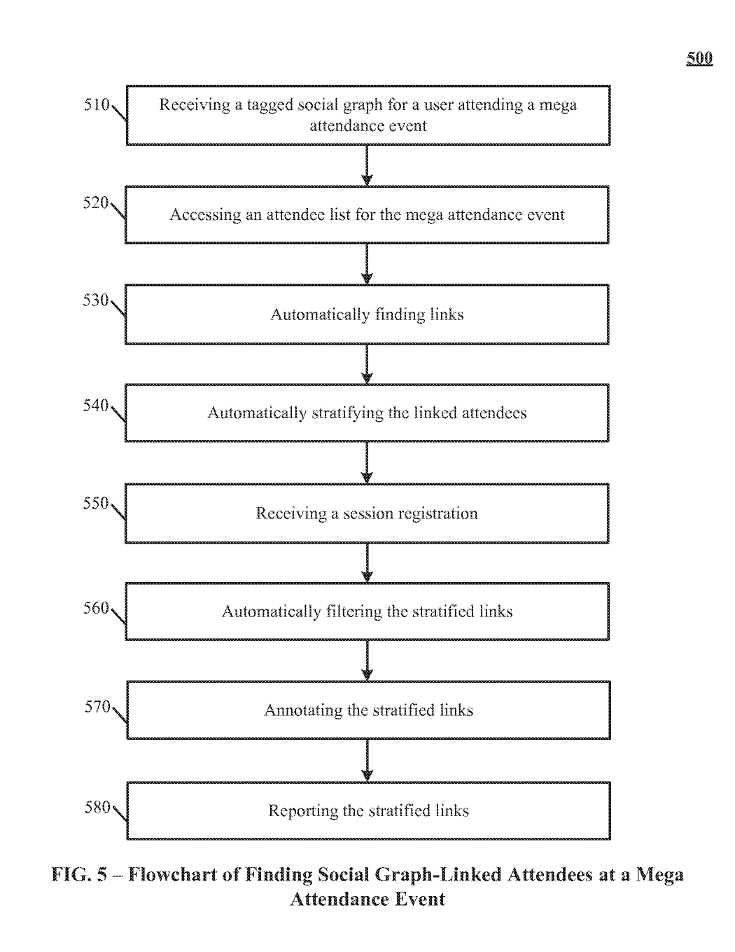

FIG. 5 is a flowchart 500 of one implementation of finding social graph-linked attendees of a mega attendance event 108. Other implementations may perform the actions in different orders and/or with different, fewer or additional actions than the ones illustrated in FIG. 5. Multiple actions can be combined in some implementations. For convenience, this flowchart is described with reference to the system that carries out a method. The system is not necessarily part of the method.

At action 510, a tagged social graph 105 for a user, such as the sales representative, attending a mega attendance event 108 is received. The mega attendance event 108 can be any event that has at least five-hundred (500) attendees. User's social graph 105 includes social graph tags that stratify, classify, categorize, and/or group persons in the user's social graph 105 based on some similar characteristics between the persons. In some implementations, social graph 105 can include records of other users in attendees' online social networks and further specify the relation and interaction types between the attendees and other users. In some implementations, social graph 105 can stratify, classify, categorize, and/or group other users in attendees' online social networks into “social graph tags” based on the preferences or interests of the attendees. The social graph tags can identify group of users in an attendee's online social network that have similar characteristics or attributes. Examples of such social graph tags or groups can include, without limitations, industry types, geographic territories, job functions, skills, expertise, products, services, age, gender, professional circles, degrees of separation, interaction strengths, social proximities, and location proximities.

An attendee list 106 for the mega attendance event 108 is accessed via communication network(s) 107 at action 520 by attendees of the mega attendance event 108. Attendee list 106 can include information related to the attendees of the mega attendance event 108. In one implementation, attendee-related information can include background information of the attendees, pictures of the attendees, biographic information of the attendees such as industries in which the attendees work in, geographic territories within which the attendees are professionally active, job functions of the attendees, and service providers of the attendees, contact information of the attendees, digital business cards, information of products or services offered or consumed by the attendees, advertising materials, technical specifications, written work product of the attendees, etc. This information can be written textual information, video information, digital pictures, audio information or other types of information stored in digital form.

At action 530, matching engine 222 finds links between the stratified persons in the social graph 105 of the user and attendees of the mega attendance event 108. In some implementations, matching engine 222 can compare alphanumeric characters in attendees mentions stored in social graph 105 to supplemental information of the attendees specified in attendees list 106. In some implementations, matching engine 222 can use natural language processing and grammar rules for finding links.

The attendees found to be linked to the user's social graph 105 are stratified using the social graph tags at action 540. The stratification can be based on tags already existing in the user's social graph 105. In one implementation, stratification can be based on similar characteristics or attributes among the found attendees identified at real-time by an attribute matching algorithm. In another implementation, stratification can be based on tags provided by the user in real-time. The social graph tags include at least industry type(s), geographic territory(ies) and job function(s) that are of interest to the user. The tags also include at least skills and expertise that are of interest to the user. The tags further include person ranks based at least in part on social proximities of persons to the user as indicated in the user's social graph 105 and person categories based at least in part on grouping of persons in the user's social graph 105. The tags also include person categories based at least in part on grouping of persons in the user's social graph 105.

At action 550, a session registration for the user to attend sessions at the mega attendance event 108 is received. The session registration includes lists of sessions and/or exhibits of the mega attendance event 108 along with the number of attendees that have registered for the sessions and/or exhibits. Event data store 206 specifies sessions and exhibits by names and locations, and additionally specifies sessions using summaries of session contents, start times, and end times. It also includes personalized schedules of individual attendees, which can list the sessions and/or exhibits that the attendee has registered for.

The stratified links can be automatically filtered at action 560 based on links between the stratified persons in the social graph 105 and attendees of sessions at the mega attendance event 108. In some implementations, user interface 400 includes filters such as attributes of sessions and/or exhibits. Examples of such attributes can include, without limitations, names, locations, summary of content, speaker, etc. of the sessions and/or exhibits. Other filters can be used to identify attendees that are tagged in the social graph of the user based on industry types, geographic territories, job functions, skills, expertise, products, services, age, gender, professional circles, degrees of separation, interaction strengths, social proximities, and location proximities.

Reporting engine 232 annotates the results of the links generated by the matching engine 222 at action 570. In some implementations, annotations indicate which attendees of the mega attendance event 108 listed in attendee list 106 match the users labeled in social graph 105 based on social profiles of the attendees in the user's online social network. In one implementation, annotations indicate names, locations, summary of content, speaker, etc. of the sessions and/or exhibits attended by the stratified attendees of the mega attendance event 108. In another implementation, annotations indicate tags based on which the attendees are stratified, classified, categorized and/or grouped. Examples of such tags include industry types, geographic territories, job functions, skills, expertise, service providers, geographic territories, job functions, products, services, age, gender, professional circles, degrees of separation, interaction strengths, social proximities, location proximities, and the like of the stratified attendees of the mega attendance event 108.

Flowchart of Connecting with Attendees at a Mega Attendance Event

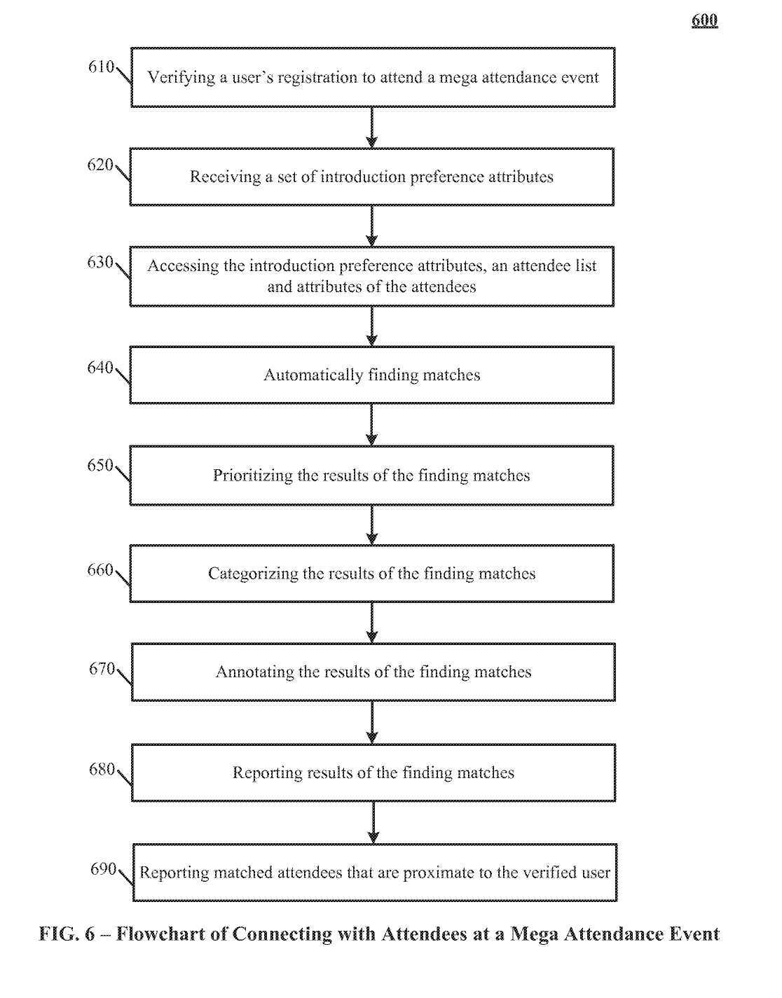

FIG. 6 illustrates a flowchart 600 of one implementation of connecting with attendees of a mega attendance event 108. Other implementations may perform the actions in different orders and/or with different, fewer or additional actions than the ones illustrated in FIG. 6. Multiple actions can be combined in some implementations. For convenience, this flowchart is described with reference to the system that carries out a method. The system is not necessarily part of the method.

At action 610, a user's registration is verified to attend a mega attendance event 108, which has at least five-hundred (500) attendees. In some implementations, the user can opt-in to the mega attendance event 108 or accept an electronic invitation for the mega attendance event 108 across a scheduling application or service running on a computing device.

In one implementation, the mega attendance event 108 can have event registrations that include detailed attendee profile questionnaires. A check-in request can be automatically generated by the registration engine 245 when an attendee's arrival is detected at the mega attendance event 108. This can be in the form of a check-in request presented to the attendee via his or her smartphone or other mobile computing device. In one implementation, the check-in request can be fully automatic, providing only a short message via the device. In another implementation, the attendee can be presented with a prompt and a response can be requested. In yet another implementation, the check-in can proceed silently without notifying the attendee. Also, an application running on the mobile computing device can be configured to automatically connect wirelessly at check-in. A check-in request can be generated when a check-in response is received from an attendee. In one implementation, the check-in response can be initiated in response to an attendee's actions such as selecting an indicator displayed on a screen of a mobile communications device. In another implementation, the attendee can share his or her check-in information with other attendees of the mega attendance event 108. In any of the above or other implementations, the check-in request can be delayed for a period of time or an indicator can be set to show that a check-in request is pending and that a response is awaited.

A set of introduction preference attributes of a user, such as the sales representative, are received at action 620. Introduction preferences 102 includes characteristics or attributes that a user prefers in attendees of a mega attendance event 108 or otherwise interact with at the mega attendance event 108. Such preferences are based on user's desire to identify leads or prospects at the mega attendance event 108 who are most likely to convert into accounts. Examples of such introduction preferences 102 include, without limitations, industries in which the attendees work in, geographic territories within which the attendees are professionally active and job functions of the attendees. Introduction preferences 102 also specify attributes such as skills and expertise of the attendees that are of interest to the user for purposes such as recruitment, identifying attendees with backgrounds similar to the user, identifying experts or “gurus” in different industries, etc.

An attendee list 106 for the mega attendance event 108 and introduction preferences 102 of the user are accessed via communication network(s) 107 at action 630. Attendee list 106 can include attributes of the attendees of the mega attendance event 108. In one implementation, attendee attributes can include background information of the attendees, pictures of the attendees, biographic information of the attendees such as industries in which the attendees work in, geographic territories within which the attendees are professionally active, job functions of the attendees, and service providers of the attendees, contact information of the attendees, digital business cards, information of products or services offered or consumed by the attendees, advertising materials, technical specifications, written work product of the attendees, etc. This information can be written textual information, video information, digital pictures, audio information or other types of information stored in digital form.

At action 640, matching engine 222 finds matches between the introduction preferences 102 of the user and attributes of attendees of the mega attendance event 108. In some implementations, matching engine 222 can compare alphanumeric characters in introduction preferences 102 to supplemental information of the attendees specified in attendees list 106. In some implementations, matching engine 222 can use natural language processing and grammar rules to find matches.

Reporting engine 232 prioritizes the results of matches generated by the matching engine 222 at action 650 based at least in part on social proximities of attendees to the verified user as indicated in verified user's social graph 105. In some implementations, the social proximities can be calculated based on at least shared backgrounds between the user and the attendees based on biographic information specified in their online social networks. These social proximities can be calculated based on connections, interactions and engagements on the online social networks between the user and the attendees.

Reporting engine 232 categories the results of matches generated by the matching engine 222 at action 660 based at least in part on grouping of attendees in verified user's social graph 105. In some implementations, the grouping can include industry types, geographic territories, job functions, skills, expertise, products, services, service providers, age, gender, professional circles, degrees of separation, interaction strengths, social proximities, location proximities, and the like.

Reporting engine 232 annotates the results of matches generated by the matching engine 222 at action 670. In some implementations, annotations indicate what attributes of the attendees of the mega attendance event 108 match the introduction preference attributes specified in the introduction preferences 102. In one implementation, annotations indicate names, locations, summary of content, speaker, etc. of the sessions and/or exhibits attended by the stratified attendees of the mega attendance event 108. In another implementation, annotations indicate tags based on which the attendees are stratified, classified, categorized and/or grouped. Examples of such tags include industry types, geographic territories, job functions, skills, expertise, service providers, geographic territories, job functions, products, services, age, gender, professional circles, degrees of separation, interaction strengths, social proximities, location proximities, and the like of the stratified attendees of the mega attendance event 108.

Reporting engine 232 presents the results of matches generated by the matching engine 222 across a user interface of a computing device at action 680. In some implementations, it can run analytics such as clustering, classification, and prioritization over the results generated by the matching engine 222. In some implementations, reporting engine 232 can stratify the results generated by the matching engine 222 into industry types, geographic territories, job functions, skills, expertise, products, services, and service providers that are of interest to the user, professional circles of the user, degrees of separation with the user, interaction strengths with the user, social proximities to the user, location proximities to the user, and the like.

The arrival of the user at the mega attendance event 108 can be automatically detected by the registration engine 245 using GPS, WiFi, NFC, or QR codes. In some implementations, registration engine 245 can perform position comparisons using GPS information to ascertain that the user is within ten feet of another attendee at the mega attendance event 108. Other threshold distances in a range of 5, 10, 20 or 50 feet can be used. In one implementation, WiFi fingerprints/triangulation, NFC proximity and/or QR scanning codes can be used to immediately detect the arrival of the user at the mega attendance event 108. Once the arrival is detected, a check-in process can be automatically initiated. A check-in request can be automatically generated by the registration engine 245 when the user's arrival is detected at the mega attendance event 108. This can be in the form of a check-in request presented to the user via his or her smartphone or other mobile computing device.

As described above, location engine 238 in conjunction with the registration engine 245 can determine a geographic location of a user, such as the sales representative, and attendees of the mega attendance event 108 based on their devices and further identify the linked attendees who are in close physical proximity to the user during the mega attendance event 108. Reporting engine 232 presents the identified attendees to the user across a user interface of a computing device at action 690

Flowchart of Connecting with Attendees at a Session

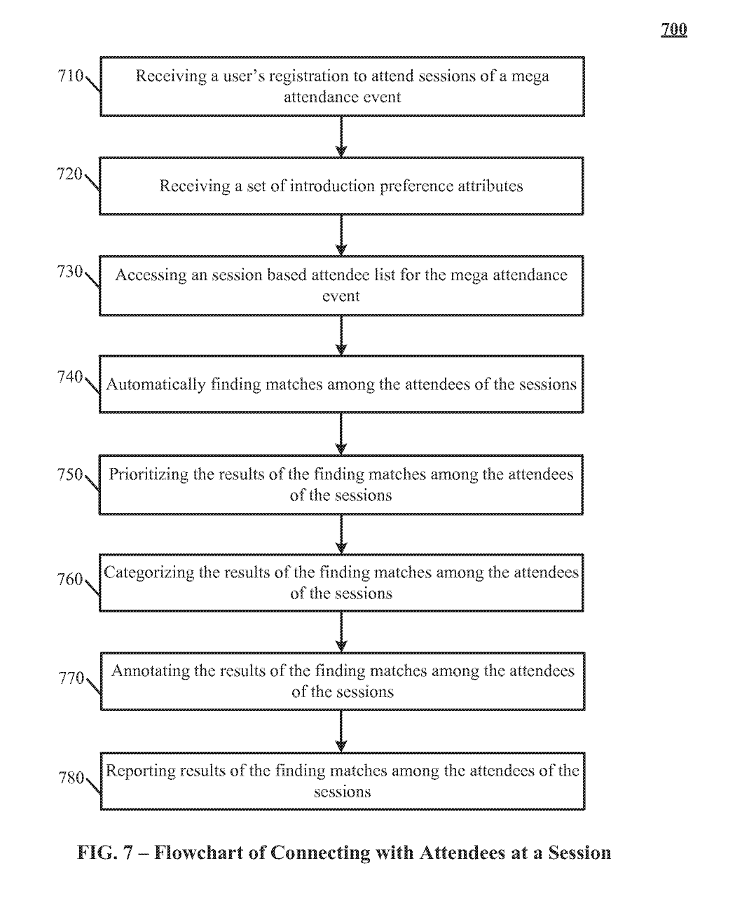

FIG. 7 is a flowchart 700 of one implementation of connecting with attendees of a session of a mega attendance event 108. Other implementations may perform the actions in different orders and/or with different, fewer or additional actions than the ones illustrated in FIG. 7. Multiple actions can be combined in some implementations. For convenience, this flowchart is described with reference to the system that carries out a method. The system is not necessarily part of the method.

While actions described in FIG. 6 apply to the entire mega attendance event 108, the following actions apply particularly to selected sessions of the mega attendance event 108. Actions 710 and 730 of FIG. 7 most strongly differ from respective actions 610 and 630 of FIG. 6 because actions 710 and 730 include receiving “session-based user registration” and “session-based attendee list” instead of event-based user registration and event-based attendee list described in FIG. 6. Using this implementation, attendees can find matches among a smaller pool of session attendees, as opposed to a much larger pool of all the attendees of the mega attendance event 108. For the forgoing reason, FIG. 7 does not include action 690 described in FIG. 6, which includes “reporting matched attendees that are proximate to the verified user,” as session attendees are often already in close proximity to each other. In other implementations, action 690 can be included in the method described in FIG. 7.

Registration of a user (such as the sales representative) to attend sessions of a mega attendance event 108 is received at action 710. The session registration includes lists of sessions and/or exhibits of the mega attendance event 108 along with the number of attendees that have registered for the sessions and/or exhibits.

In one implementation, the mega attendance event 108 can have event registrations that include detailed attendee profile questionnaires. A check-in request can be automatically generated by the registration engine 245 when an attendee's arrival is detected at the mega attendance event 108. This can be in the form of a check-in request presented to the attendee via his or her smartphone or other mobile computing device. In one implementation, the check-in request can be fully automatic, providing only a short message via the device. In another implementation, the attendee can be presented with a prompt and a response can be requested. In yet another implementation, the check-in can proceed silently without notifying the attendee. Also, an application running on the mobile computing device can be configured to automatically connect wirelessly at check-in. A check-in request can be generated when a check-in response is received from an attendee. In one implementation, the check-in response can be initiated in response to an attendee's actions such as selecting an indicator displayed on a screen of a mobile communications device. In another implementation, the attendee can share his or her check-in information with other attendees of the mega attendance event 108. In any of the above or other implementations, the check-in request can be delayed for a period of time or an indicator can be set to show that a check-in request is pending and that a response is awaited.

A set of introduction preference attributes of a user, such as the sales representative are received at action 720. Introduction preferences 102 includes characteristics or attributes that the user prefers in attendees of a mega attendance event 108 or otherwise interact with at the mega attendance event 108. Such preferences is based on user's desire to identify leads or prospects at the mega attendance event 108 who are most likely to convert into accounts. Examples of such introduction preferences 102 include, without limitations, industries in which the attendees work in, geographic territories within which the attendees are professionally active and job functions of the attendees. Introduction preferences 102 also specify attributes such as skills and expertise of the attendees that are of interest to the user for purposes such as recruitment, identifying attendees with backgrounds similar to the user, identifying experts or “gurus” in different industries, etc.

An attendee list 106 for a selected session of the mega attendance event 108 and introduction preferences 102 of the user are accessed via communication network(s) 107 at action 730. A session-based attendee list 106 can include attributes only of the attendees of the selected session. In one implementation, sessions and exhibits can be specified by names and locations, summaries of session contents, start times, and end times.

At action 740, matching engine 222 finds matches between the introduction preferences 102 of the user and attributes of attendees of sessions of the mega attendance event 108. In some implementations, matching engine 222 can compare alphanumeric characters in introduction preferences 102 to supplemental information of the attendees specified in attendees list 106. In some implementations, matching engine 222 can use natural language processing and grammar rules to find matches.

Reporting engine 232 prioritizes the results of the finding matches generated by the matching engine 222 at action 750 based at least in part on social proximities of attendees to the user as indicated in user's social graph 105. In some implementations, the social proximities can be calculated based on at least shared backgrounds, such as employment, professional activity or education, between the user and the attendees based on biographic information specified in their online social networks. These social proximities can be calculated based on connections, interactions and engagements on the online social networks between the user and the attendees.

Reporting engine 232 categories the results of matches generated by the matching engine 222 at action 760 based at least in part on grouping of attendees in the user's social graph 105. In some implementations, the grouping can include industry types, geographic territories, job functions, products, services, age, gender, professional circles, degrees of separation, interaction strengths, social proximities, location proximities, and the like.

Reporting engine 232 annotates the results of matches generated by the matching engine 222 at action 770. In some implementations, annotations indicate what attributes of the attendees of sessions of the mega attendance event 108 match the introduction preference attributes specified in the introduction preferences 102. In one implementation, annotations indicate names, locations, summary of content, speaker, etc. of the sessions and exhibits attended by the stratified attendees of the mega attendance event 108. In another implementation, annotations indicate tags based on which the attendees are stratified, classified, categorized and/or grouped. Examples of such tags include industry types, geographic territories, job functions, skills, expertise, service providers, geographic territories, job functions, products, services, age, gender, professional circles, degrees of separation, interaction strengths, social proximities, location proximities, and the like of the stratified attendees of the mega attendance event 108.

Reporting engine 232 presents the results of matches generated by the matching engine 222 across a user interface of a computing device at action 780. In some implementations, it can run analytics such as clustering, classification, and prioritization over the results generated by the matching engine 222. In some implementations, reporting engine 232 can stratify the results generated by the matching engine 222 into industry types preferred by the user, professional circles of the user, degrees of separation with the user, interaction strengths with the user, social proximities to the user, location proximities to the user, and the like.

### Computer System

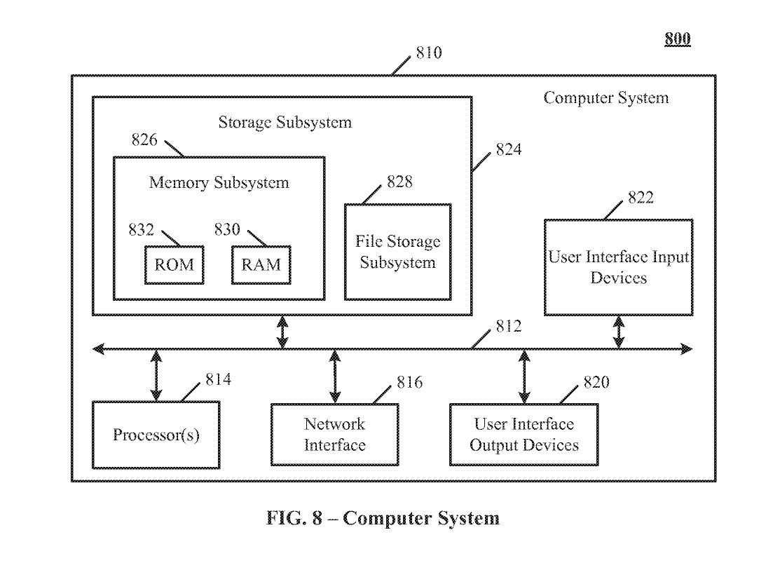

FIG. 8 is a block diagram of an example computer system 800 for feed customization and streamlining. FIG. 8 is a block diagram of an example computer system, according to one implementation. Computer system 810 typically includes at least one processor 814 that communicates with a number of peripheral devices via bus subsystem 812. These peripheral devices can include a storage subsystem 824 including, for example, memory devices and a file storage subsystem, user interface input devices 822, user interface output devices 820, and a network interface subsystem 818. The input and output devices allow user interaction with computer system 810. Network interface subsystem 818 provides an interface to outside networks, including an interface to corresponding interface devices in other computer systems.

User interface input devices 822 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 810.

User interface output devices 820 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 810 to the user or to another machine or computer system.

Storage subsystem 824 stores programming and data constructs that provide the functionality of some or all of the modules and methods described herein. These software modules are generally executed by processor 814 alone or in combination with other processors.

Memory 828 used in the storage subsystem can include a number of memories including a main random access memory (RAM) 830 for storage of instructions and data during program execution and a read only memory (ROM) 832 in which fixed instructions are stored. A file storage subsystem 828 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 828 in the storage subsystem 824, or in other machines accessible by the processor.

Bus subsystem 812 provides a mechanism for letting the various components and subsystems of computer system 810 communicate with each other as intended. Although bus subsystem 812 is shown schematically as a single bus, alternative implementations of the bus subsystem can use multiple busses.

Computer system 810 can be of varying types including a workstation, server, computing cluster, blade server, server farm, or any other data processing system or computing device. Due to the ever-changing nature of computers and networks, the description of computer system 810 depicted in FIG. 8 is intended only as one example. Many other configurations of computer system 810 are possible having more or fewer components than the computer system depicted in FIG. 8.

### Particular Implementations

In one implementation, a method is described from the perspective of a server receiving messages from user software. The method includes assisting a user attending a mega attendance event to connect with attendees of the event. It includes verifying a user's registration to attend a mega attendance event that has at least 500 attendees. It also includes receiving a set of introduction preference attributes and accessing the introduction preference attributes, an attendee list for the mega attendance event, and attributes of the attendees of the event. It further includes automatically finding matches between the introduction preference attributes and attendees' attributes and reporting results of the finding matches to a further computer-implemented process.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as systems and actors, attendee matching environment, attendee matching records, etc.

The method further includes assembling the introduction preference attributes from an external source for the attendees. It includes the introduction preference attributes including at least industry type(s), geographic territory(ies) and job function(s) that are of interest to the verified user. It also includes the introduction preference attributes including at least skills and expertise that are of interest to the verified user. It further includes the introduction preference attributes including at least service providers that are verified user's competitors and service attendees.

The method further includes prioritizing the results of the finding matches based at least in part on social proximities of attendees to the verified user as indicated in verified user's social graph. It also includes categorizing the results of the finding matches based at least in part on grouping of attendees in verified user's social graph. It further includes annotating the results of the finding matches to indicate what attributes of the attendees of the event match the introduction preference attributes.

The method further includes determining a geographic location of the verified user and attendees of the event based on their devices, identifying attendees whose attributes match the introduction preference attributes and who are in physical proximity to the verified user during the event and reporting the identified attendees to the verified user across a user interface.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In another implementation, a method is described from the perspective of a server receiving messages from user software. The method includes assisting a user attending a mega attendance event to connect with attendees of the event. It includes receiving a tagged social graph for a user attending a mega attendance event that has at least 500 attendees. The social graph tags apply to persons in the user's social graph. It includes accessing an attendee list for the mega attendance event and automatically finding links between the persons in the user's social graph and attendees of the mega attendance event. It also includes automatically stratifying the linked attendees using the social graph tags. It further includes reporting the stratified linked attendees to a further computer-implemented process.

This method and other implementations of the technology disclosed can include one or more of the following features and/or features described in connection with additional methods disclosed.

The method further includes receiving a session registration for the user to attend sessions at the mega attendance event and automatically filtering the stratified linked attendees based on links between the persons in user's social graph and attendees of sessions at the mega attendance event.

The method further includes the social graph tags including at least industry type(s), geographic territory(ies) and job function(s) that are of interest to the user, skills and expertise that are of interest to the user and service providers that are at least user's competitors and service the attendees.

The method further includes the social graph tags including person ranks based at least in part on social proximities of persons to the user as indicated in the user's social graph and person categories based at least in part on grouping of persons in the user's social graph.

The method further includes determining a geographic location of the user and attendees of the event based on their devices, identifying the linked attendees who are in physical proximity to the user during the event and reporting the identified attendees to the user across a user interface.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

In another implementation, a method is described from the perspective of a server receiving messages from user software. The method includes assisting a user attending a mega attendance event to connect with attendees of the event. It includes receiving a user's registration to attend sessions at a mega attendance event that has at least 500 attendees. It also includes receiving a set of introduction preference attributes and accessing an attendee list for the mega attendance event. It further includes automatically finding matches between the introduction preference attributes and attributes of attendees of the sessions and reporting results of the finding matches to a further computer-implemented process.

This method and other implementations of the technology disclosed can include one or more of the following features and/or features described in connection with additional methods disclosed.

The method further includes the introduction preference attributes being assembled from an external source for the attendees of the sessions. It includes the introduction preference attributes including at least industry type(s), geographic territory(ies) and job function(s) that are of interest to the user, skills and expertise that are of interest to the user and service providers that are user's competitors and service the attendees of the sessions.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

1-20. (canceled)

21. A server for producing a customized user interface, the computer system comprising:
a network interface of the server, the network interface configured to:
receive, at a first time, an indication of a presence, at a location of an event, of a computing device of an individual,
receive a social graph of the individual,
receive a list of attendees of the event,
receive, at a second time, an indication of a presence, at the location of the event, of a computing device of a first other individual, wherein the first other individual is on the list of attendees, the second time being before the first time,
receive, at a third time, an indication of a presence, at the location of the event, of a computing device of a second other individual, wherein the second other individual is on the list of attendees, the third time being after the first time,
receive, from the computing device of the individual, a first request, wherein the first request is for the customized interface, and
transmit, to the computing device of the individual in response to the first request, the customized user interface; and
a processor of the server, the processor configured to:
determine an existence of a link, within the social graph, between the individual and the first other individual,
determine an existence of a link, within the social graph, between the individual and the second other individual,
produce, at the first time, the customized user interface, wherein the customized user interface is configured to present, on a screen of the computing device of the individual prior to a transmission, from the computing device of the individual, or a second request:
a list that includes the first other individual,
a first profile of the first other individual, and
a link to a second profile of the first other individual, wherein an information in the first profile of the first other individual is a summary of an information in the second profile of the first other individual, and wherein the second request is for additional information about the first other individual, and
produce, at the third time, the customized user interface, wherein the customized user interface is configured to present, on the screen of the computing device of the individual:
a list that includes the first other individual and the second other individual,
the first profile of the first other individual,
the link to the second profile of the first other individual,
a first profile of the second other individual, and
a link to a second profile of the second other individual, wherein an information in the first profile of the second other individual is a summary of an information in the second profile of the second other individual.
